(19) United States
(12) Patent Application Publication
(10) Pub. No.: US 2015/0290864 A1
(43) Pub. Date: Oct. 15, 2015

(54) METHOD FOR PRODUCING A BLOW MOULDED FUEL FILLER SYSTEM FOR A MOTOR VEHICLE AND FUEL FILLER SYSTEM FOR A MOTOR VEHICLE

(71) Applicant: ILLINOIS TOOL WORKS INC., Glenview, IL (US)

(72) Inventors: Christian Beck, Roettingen (DE); Matthias Kapaun, Gaukoenigshofen (DE)

(21) Appl. No.: 14/439,697

(22) PCT Filed: Nov. 12, 2013
(86) PCT No.: PCT/US13/69544

§ 371 Date: Apr. 30, 2015

(30) Foreign Application Priority Data
Nov. 16, 2012 (DE) 10 2012 022 395.1

(51) Int. Cl. B29C 49/20; B60K 15/04; B29C 49/04

(52) U.S. Cl. CPC B29C 49/20; B29C 49/04; B60K 15/04; B29K 2101/12

(57) ABSTRACT

In a method for producing a fuel filler system, a tube shaped plastic part is introduced into a molding tool. A pressure gas pin is inserted into a first end of the plastic part. Pressure gas is introduced into the plastic part through the pressure gas pin, whereby the plastic part is expanded and adjusted to the contour of the inner walls of the molding tool. The pressure gas pin is retracted, and a constriction of the first end of the plastic part closing around the pressure gas pin is separated. A fuel filler device is inserted into the first end of the plastic part. A contact pressure is exerted, whereby a welding of the fuel filler device with the first end of the plastic part occurs. The finished plastic part is removed from the molding tool together with the fuel filler device welded therein.

The invention relates to a method for producing a fuel filler system for a motor vehicle. The invention furthermore relates to a fuel filler system for a motor vehicle. There is a known practice in the case of fuel filler systems of inserting fuel filler devices, e.g. capless or capped fuel filler devices, into plastic pipes, which are then connected to the fuel tank of a vehicle. The fastening of the fuel filler device in the plastic pipe can be effected mechanically, with corresponding complex fastening and sealing measures being required. Fastening can also be effected by material engagement as part of a welding process. The plastic pipes used here are often produced in a blow moulding process. The insertion of the fuel filler device, e.g. the welding in the plastic pipe, is then effected in a separate working step after the plastic pipe has been removed in dimensionally stable form from the moulding tool used for the blow moulding process. Both abovementioned methods for introducing the fuel filler device into the plastic pipe are complex.

It is therefore the underlying object of the invention to provide a method and a fuel filler system of the abovementioned type which involves less outlay on production than the prior art.

The invention achieves this object through the subjects of independent claims 1 and 14. Advantageous embodiments can be found in the dependent claims, the description and the figures.

The invention achieves the object, on the one hand, by a method for producing a fuel filler system for a motor vehicle, comprising the steps:
a tube shaped plastic part is introduced into a moulding tool,
a pressure gas pin is inserted into a first end of the plastic part and the moulding tool is closed around the first end of the plastic part accommodating the pressure gas pin,
in case the opposite second end of the plastic part is still open, this end is also closed,
pressure gas is introduced into the plastic part through the pressure gas pin, whereby the plastic part is expanded and adjusted to the contour of the inner walls of the moulding tool for providing a pipe shape,
the pressure gas pin is retracted from the plastic part and a constriction of the first end of the plastic part resulting from the closing around the pressure gas pin is separated,
a fuel filler device is inserted into the first end of the plastic part while the plastic part is still located in the moulding tool,
a contact pressure is exerted from the outside onto the first end of the plastic part accommodating the fuel filler device, whereby a welding of the fuel filler device with the first end of the plastic part occurs,
the finished plastic part is removed from the moulding tool together with the fuel filler device welded therein.

Thus, the fuel filler system according to the invention is produced in a blow moulding process. For this purpose, a tube shaped plastic part is inserted into a mould cavity of a moulding tool. The plastic part is composed of a thermoplastic of a kind known per se. It is at a sufficient temperature for the blow moulding process. This temperature can be generated before and/or after insertion into the moulding tool. For example, the tube shaped plastic part can have been produced in an extrusion process and inserted into the moulding tool substantially directly after the extrusion process. The residual heat from the extrusion process can then be used partially or completely for the blow moulding process.

In the moulding tool, the tube shaped plastic part is expanded and pressed against the inner walls of the moulding tool to form a plastic pipe by introducing pressure gas, e.g. compressed air. Before the pressure gas is introduced, the tube shaped plastic part must be sealed in a gastight manner. For this purpose, the moulding tool is closed around the first end of the plastic part accommodating the pressure gas pin. The opposite, second end of the tube shaped plastic part must also be sealed. For this purpose, the moulding tool can also be closed around the second end of the plastic part, for example.

After the pressure gas pin used to introduce the pressure gas has been removed and a constriction of the first end which has arisen as the first end was closed has been separated, a fuel filler device is, according to the invention, inserted into the first end while the plastic part is still in the moulding tool. The fuel filler device is then welded in the plastic part by exerting a suitable contact pressure from the outside in the presence of a sufficient welding temperature, likewise while the plastic part is still in the moulding tool. The fuel filler device is thus materially incorporated into the plastic part during the blow moulding process itself, in particular while still in the moulding tool used for this purpose. A constriction which has formed through the optional closure of the second end of the plastic part can of course also be separated before or after the insertion of the fuel filler device in order to produce a plastic pipe open at both ends. After a cooling process sufficient for the dimensional stability of the plastic part, the now pipe shaped plastic part is removed from the moulding tool together with the fuel filler device incorporated materially into it. Owing to the material connection, no seals are required here between the plastic part and the fuel filler device inserted therein.

Moreover, the material connection ensures an improvement in the fuel resistance and a reduction in emissions, especially fuel vapors, in the region of the plastic pipe. In comparison with conventional welding of the fuel filler device in a separate process step after the removal of the plastic pipe from the blow moulding tool or indeed in comparison with a crimping method used in the prior art, the production of the fuel filler system is simplified according to the invention. The components required for fastening and production are also reduced as compared with the prior art. Moreover, the serviceability of the component is improved. In principle, the invention can be employed for conventional deflectors with or without a misfuel inhibitor (MFI) and “capless” filler systems with or without an MFI, systems with one or more sealed caps, serviceable or non-serviceable systems. The fuel filler device inserted can be of single-part or multipart design. It can involve a complete capless filler system or just an assembly pot. The fuel filler system produced according to the invention can then be installed in a motor vehicle, in particular a passenger car or a truck, where it is connected to a fuel tank of the motor vehicle.

It should be explicitly noted that the fuel filler device inserted into and welded to the pipe shaped plastic part in the moulding tool does not have to be complete at this stage. It is also possible for the fuel filler device inserted to be merely a filler neck or an adapter socket for a filler system to be inserted subsequently, e.g. outside the moulding tool. It is also possible for further components of the fuel filler device to be inserted in the latter after the welding of the fuel filler device in the plastic part and possibly also after the removal of the fuel filler system from the moulding tool.

As already mentioned, the tube shaped plastic part can be provided in an extrusion process. Production is thereby simplified, and the residual heat from the extrusion process can be used, in particular used completely, for the subsequent blow moulding process in the moulding tool, as explained at the outset.

The closing of the moulding tool around the first end of the plastic part accommodating the pressure gas pin can be effected through at least one moveable section of the moulding tool. The optional closing of the second end of the plastic part can furthermore likewise be effected through at least one moveable section of the moulding tool. In particular, the movable sections of the moulding tool can be constricted during this process and thus reliably close any openings in the tube shaped plastic part for the blow moulding process. At the first end, constriction takes place around the first end and the pressure gas pin situated therein since it is via the latter that the pressure gas for the blow moulding process is subsequently introduced into the moulding tool.

The separation of the constriction of the first end of the plastic part produced by the closing around the pressure gas pin can be effected through at least one moveable section of the moulding tool. In particular, the at least one movable section of the moulding tool can close around the constriction of the first end and thus separate the constriction. The constriction has formed through the closing of the moulding tool around the first end with the pressure gas pin situated therein before the introduction of the pressure gas. However, it is also possible to provide a separate cutting device which closes around the constriction of the first end in order in this way to separate the constriction. The decisive factor is that the first end should have a sufficiently large opening after the separation process for the insertion of the fuel filler device. In a corresponding fashion, it is also possible for a constriction that may be present in the region of the second end to be separated by means of at least one movable section of the moulding tool or by a separate cutting device, for example.

According to another embodiment, the contact pressure exerted for welding the fuel filler device with the first end of the plastic part can be effected through at least one moveable section of the moulding tool. The at least one movable section of the moulding tool can once again be constricted and thus exert the contact pressure required for welding on the first end of the plastic part and on the fuel filler device situated therein. The at least one moveable section of the moulding tool can comprise at least one bevelled or rounded edge. The at least one bevelled or rounded edge can be provided on a side of the at least one moveable section of the moulding tool which is facing away from the opening of the first end of the plastic part. In particular, the bevelled or rounded edge can be designed as a chamfer. This ensures that there is no damage to the wall of the plastic part during the exertion of the contact pressure required for welding, e.g. due to a sharp edge being pressed into the wall. The bevelled edge, which reliably prevents this, can run at an angle of between 30° and 60° to the longitudinal direction of the tube shaped plastic part, for example.

It may be mentioned in principle that all or some of the movable sections of the moulding tool can move between an open and a closed position in a direction substantially perpendicular to the longitudinal direction of the tube shaped plastic part.

As already explained, the welding of the fuel filler device in the plastic part is effected by a contact pressure from the outside in conjunction with a sufficient temperature of the plastic part. In this case, a temperature of the plastic part used for the welding can be provided essentially completely through a residual heat of the plastic part after introducing the pressure gas for expanding the tube shaped plastic part. In particular, it is possible to make substantially exclusive use of the residual heat from the blow moulding process for the temperature of the plastic part used or required for the welding. No separate heating source is then required for the welding process. This makes the production method particularly simple and quick. As an alternative, however, it is also possible for a temperature necessary for the welding of the plastic part to be at least partially produced through a separate heating source, in particular completely through a separate heating source. The separate heating source then produces the required temperature of the plastic part, possibly in addition to a persisting residual heat of the plastic part after the introduction of the pressure gas for expanding the tube shaped plastic part.

As a fuel filler device a guiding device for a fuel filler pistol can be inserted. This can be a fuel filler head, for example. As already explained, it is also possible to insert a capless fuel filler device as a fuel filler device. As has likewise been explained, it is also possible for a fuel filler device with a misfuel inhibitor (MFI) to be inserted as a fuel filler device.

According to a further aspect, the invention also relates to a method for producing a fuel filler system for a motor vehicle, comprising the steps: at least two plastic parts are assembled to a pipe shaped plastic part, wherein a fuel filler device is inserted into the pipe shape formed by the at least two plastic parts, and the at least two plastic parts are welded together for forming the pipe shaped plastic part, wherein also welding of the fuel filler device in the pipe shaped plastic part occurs.

The at least two plastic parts can be two half shells, for example, which, when assembled, form the pipe shaped plastic part. The at least two plastic parts can be produced in a plastic injection moulding process, for example. The welding can be effected in any suitable manner. For example, an ultrasonic welding method can be employed. Welding of the fuel filler device in the at least two plastic parts is in turn effected in a simple manner in one method step. This aspect of the invention may be of interest especially for diesel vehicles, where the emissions requirements are lower than with spark ignition motor vehicles.

The invention furthermore achieves the object through a fuel filler system for a motor vehicle, produced by one of the methods according to the invention.

An illustrative embodiment of the invention is explained in greater detail below with reference to schematic figures, in which:

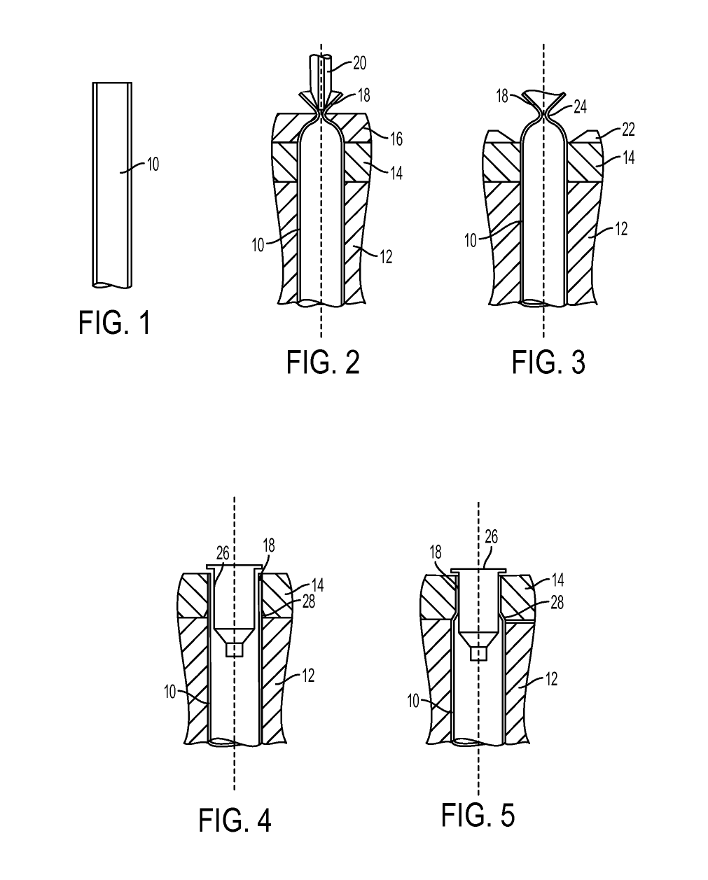

FIG. 1 shows a section of a tube shaped plastic part used in the method according to the invention,

FIG. 2 shows a first method step of the method according to the invention in a sectional view,

FIG. 3 shows a second method step of the method according to the invention in a sectional view,

FIG. 4 shows a third method step of the method according to the invention in a sectional view, and

FIG. 5 shows a fourth method step of the method according to the invention in a sectional view.

Unless stated otherwise, the same reference signs denote identical subjects in the figures. A section of a tube shaped plastic part 10, e.g. a circular-cylindrical plastic part, is shown in FIG. 1. The plastic part 10 is composed of a thermoplastic and has been produced in an extrusion process in the illustrative embodiment shown. In the method according to the invention shown in FIG. 2, the tube shaped plastic part 10 from FIG. 1 is inserted into a moulding tool formed by a plurality of sections 12, 14, 16.

In the state shown in FIG. 2, a pressure gas pin 20 has been inserted into the first end 18 of the tube shaped plastic part 10, that at the top in FIG. 2. Gas, e.g. air, can be introduced into the tube shaped plastic part 10 under high pressure by means of a pressure gas source (not shown), e.g. a compressed air source, via the pressure gas pin 20. That section 16 of the moulding tool which is at the top in FIG. 2 has been moved in such a way after the insertion of the pressure gas pin 20 that the first end 18 of the tube shaped plastic part 10, said end being shown in FIG. 2, is closed gastightly around the pressure gas pin 20. The opposite, second end of the tube shaped plastic part 10, which is not shown in the figures, is likewise closed in a gastight manner. To reach the state of the method in FIG. 2, pressure gas is then introduced into the tube shaped plastic part 10 via the pressure gas pin 20, whereby the tube shaped plastic part 10 is expanded and adapted to the contour of the inner walls which is defined by the moulding tool, in particular sections 12, 14, 16 thereof. The temperature of the tube shaped plastic part 10 which is required for this blow moulding process can arise from the residual heat of the tube shaped plastic part 10 after the extrusion process.

In FIG. 3, it can be seen that that section 16 of the moulding tool which is at the top in FIG. 2 has been removed from the tube shaped plastic part 10, in particular from the first end 18 thereof. By means of a cutting device indicated by reference sign 22 in FIG. 3, the first end 18 of the tube shaped plastic part 10, in particular a constriction 24 produced therein during the closing of the first end 18, is then separated. Any constriction which may be present in the region of the second end (not shown) of the tube shaped plastic part 10 can be separated in the same way, resulting overall in a tube shaped plastic part 10 defined by the contour of the moulding tool.

After the removal of the cutting device 22, a fuel filler device 26 is inserted into the first end 18 of the plastic part 10 while the plastic part is still in the moulding tool, as can be seen in FIG. 4. The fuel filler device 26 can be, for example, a guiding device for a fuel filler pistol, a filler neck or an adapter socket for receiving a fuel filler system to be inserted subsequently. The fuel filler device 26 can also be a fuel filler device with or without a misfuel inhibitor (MFI). The fuel filler device 26 can furthermore be a capless fuel filler device or a fuel filler device having at least one cap.

In the next method step, which is illustrated in FIG. 5, section 14 of the moulding tool is moved inward, thereby exerting a contact pressure from the outside on the first end 18 of the plastic part 10, the end accommodating the fuel filler device 26. As can be seen in FIG. 5, this involves a constriction of the plastic part 10 in the region of its first end 18 toward the fuel filler device 26 situated therein. By virtue of this contact pressure and of the residual heat of the tube shaped plastic part 10 remaining from the preceding blow moulding process, welding of the fuel filler device 26 in the tube shaped plastic part 10 occurs, especially in the region of the first end 18 thereof. If necessary, a separate heating source can additionally be provided to make available a temperature required for the welding process. As can furthermore be seen in FIG. 5, that section 14 of the moulding tool which is at the top in FIG. 5 has, at its bottom end, a bevelled edge 28. This bevelled edge 28 prevents a sharp edge from being pressed into the wall of the plastic part 10 as the contact pressure is exerted, which could lead to damage of the plastic part 10.

1. Method for producing a fuel filler system for a motor vehicle, comprising the steps:
a tube shaped plastic part is introduced into a moulding tool,
a pressure gas pin is inserted into a first end of the plastic part and the moulding tool is closed around the first end of the plastic part accommodating the pressure gas pin,
in case the opposite second end of the plastic part is still open, this end is also closed,
pressure gas is introduced into the plastic part through the pressure gas pin, whereby the plastic part is expanded and adjusted to the contour of the inner walls of the moulding tool for providing a pipe shape,
the pressure gas pin is retracted from the plastic part and a constriction of the first end of the plastic part resulting from the closing around the pressure gas pin is separated,
a fuel filler device is inserted into the first end of the plastic part while the plastic part is still located in the moulding tool,
a contact pressure is exerted from the outside onto the first end of the plastic part accommodating the fuel filler device, whereby a welding of the fuel filler device with the first end of the plastic part occurs,
the finished plastic part is removed from the moulding tool together with the fuel filler device welded therein.

2. Method according to claim 1, wherein the tube shaped plastic part is provided in an extrusion process.

3. Method according to claim 1, wherein a temperature of the plastic part necessary for the welding is provided essentially completely through a residual heat of the plastic part after introducing the pressure gas for expanding the tube shaped plastic part.

4. Method according to claim 1, wherein a temperature necessary for the welding of the plastic part is at least partially produced through a separate heating source.

5. Method according to claim 1, wherein the closing of the moulding tool around the first end of the plastic part accommodating the pressure gas pin is effected through at least one moveable section of the moulding tool.

6. Method according to claim 1, wherein the optional closing of the second end of the plastic part is effected through at least one moveable section of the moulding tool.

7. Method according to claim 1, wherein the separation of the constriction of the first end of the plastic part produced by the closing around the pressure gas pin is effected through at least one moveable section of the moulding tool.

8. Method according to claim 1, wherein the contact pressure exerted for welding the fuel filler device with the first end of the plastic part is effected through at least one moveable section of the moulding tool.

9. Method according to claim 8, wherein the at least one moveable section of the moulding tool comprises at least one bevelled or rounded edge.

10. Method according to claim 9, wherein the at least one bevelled or rounded edge is provided on a side of the at least one moveable section of the moulding tool which is facing away from the opening of the first end of the plastic part.

11. Method according to claim 1, wherein as a fuel filler device a guiding device for a fuel filler pistol is inserted.

12. Method according to claim 1, wherein as a fuel filler device a capless fuel filler device is inserted.

13. Method according to claim 1, wherein as a fuel filler device a fuel filler device with a misfuel inhibitor is inserted.

14. Method for producing a fuel filler system for a motor vehicle, comprising the steps:
at least two plastic parts are assembled to a pipe shaped plastic part, wherein a fuel filler device is inserted into the pipe shape formed by the at least two plastic parts,
the at least two plastic parts are welded together for forming the pipe shaped plastic part, wherein also welding of the fuel filler device in the pipe shaped plastic part occurs.

15. Fuel filler system for a motor vehicle, produced in a method according to claim 1.
